(19) United States
(12) Patent Application Publication
(10) Pub. No.: US 2023/0216417 A1
(43) Pub. Date: Jul. 6, 2023

(54) FLYBACK CONVERTER WITH INDIRECT ESTIMATION OF PRIMARY- SIDE VOLTAGE AT THE SECONDARY-SIDE

(71) Applicants: Luis LEON LARA, Decatur, GA (US); Hamid BEHJATI, North Reading, MA (US); OSRAM SYLVANIA INC., Wilmington, MA (US)

(72) Inventors: Hamid Behjati, North Reading, MA (US); Luis Manuel Leon Lara, Wilimington, MA (US)

(21) Appl. No.: 17/928,117

(22) PCT Filed: Jun. 1, 2021
(86) PCT No.: PCT/US2021/035198

§ 371 Date: Nov. 28, 2022

Related U.S. Application Data
(60) Provisional application No. 63/032,471, filed on May 29, 2020.

(51) Int. Cl. H02M 3/335; H02M 1/34

(52) U.S. Cl. CPC H02M 3/33523; H02M 1/348

(57) ABSTRACT

A flyback converter with indirect estimation of primary-side voltage at the secondary-side. The converter includes a primary voltage sensing circuit coupled to the second winding of the converter and being configured to establish an output voltage when a switch of the converter is in the first state and a first diode of the converter is reversed biased, the output voltage being representative of a voltage across the primary winding.

### CROSS-REFERENCE TO RELATED APPLICATIONS

The present application is an international application of, and claims priority to, U.S. Provisional Application No. 63/032,471, filed, May 29, 2020, the entire teachings of which are hereby incorporated herein by reference.

### TECHNICAL FIELD

The present application relates to a voltage converter circuit, and more particularly, to a flyback converter with indirect estimation of primary-side voltage at the secondary-side.

### BACKGROUND

A “flyback” converter is a known type of a switching converter used in circuits for driving solid state light sources, e.g., light emitting diode (LED)-based light sources, and/or for establishing a low power direct current (DC) supply for primary and/or secondary circuits, e.g., microcontrollers, application specific integrated circuits (ASICS). A flyback converter includes a transformer having a primary winding and a secondary winding. The primary winding side (referred to herein as the “primary-side”) of the transformer may be coupled to the input, i.e., a rectified alternating current (AC) output of a rectifier or a DC input. A regulated DC output voltage is provided at the secondary winding side (referred to herein as the “secondary-side”). One advantage of a flyback converter is the primary-side is galvanically isolated from the secondary-side. Galvanic isolation between the primary and secondary-sides of the converter is typically a requirement of a driver to power solid state light sources, as well as other applications.

However, the presence of an isolation barrier means that it is not possible to measure the primary-side voltage of the flyback converter from the secondary-side without using another isolated communication channel, such as an optocoupler. Having a measurement of the primary-side voltage enables a number of features and applications, such as but not limited to monitoring supply voltage for early detection of power loss; timely saving non-volatile memory within a microcontroller; detecting faults; entering one or more fail safe modes; and the like. Access to primary-side voltage information increases the available feature sets of a driver to power solid state light sources.

### SUMMARY

Though the use of an isolated communication channel, such as an optocoupler, permits measurement of the primary-side voltage of a flyback converter from the secondary-side, this is not without drawbacks. Isolated communication channels, such as optocouplers, are costly and require additional circuitry, such as auxiliary circuits to measure the primary-side voltage, converter circuits to convert that measurement to a digital signal, and transfer circuits to transfer it to the secondary-side of the converter. These additional circuits take up additional physical space within the driver. Further, a low cost optocoupler has a small bandwidth, and thus to obtain faster communication speed, a more expensive optocoupler is used. As drivers to power solid state light sources become more ubiquitous, the market requires that they also become smaller and less expensive. Using isolated communication channels, such optocouplers, and the additional circuitry required thereby, cuts against both reductions in physical size as well as cost. However, removing these devices and circuits prohibits the use of additional desired features in a driver with a flyback converter.

Embodiments are disclosed that provide low-cost yet effective methods and apparatuses to indirectly estimate the primary-side voltage of a flyback converter from its secondary-side, without the use of isolated communications channels and related circuitry and without breaking the isolation barrier. Embodiments may achieve this using only a few additional passive components having minimal cost, using an analog voltage output signal so that bandwidth can be very high and using only minimal space compared to use of an optocoupler and additional circuitry. The features and applications that are enabled by having an estimation of the primary-side voltage at the secondary-side are thus available, while also meeting the market requirements of making the driver smaller and less costly.

According to one aspect of the disclosure there is provided a flyback converter circuit including a transformer having a primary winding and a secondary winding; a switch coupled to the primary winding, the switch having a first state and a second state; a controller coupled to the switch configured to cycle the switch between the first and second states to control current flow through the primary winding; a first diode coupled the secondary winding, the first diode configured to be reverse biased when the switch is in the first state to allow energy to be stored in the transformer; an output capacitor coupled to the first diode, the first diode being configured to be forward biased when the switch is in the second state to allow energy in the transformer to charge the output capacitor; and a primary voltage sensing circuit coupled to the second winding and being configured to establish an output voltage when the switch is in the first state and the first diode is reversed biased, the output voltage being representative of a voltage across the primary winding.

In some embodiments of the flyback converter circuit, the primary voltage sensing circuit includes a second diode coupled to the secondary winding, the second diode being configured to be forward biased when the first diode is reverse biased. In some embodiments the second diode is coupled to the secondary winding and to ground through a second capacitor. In some embodiments, the primary voltage sensing circuit further includes a first resistor having a first terminal coupled to the second diode and the second capacitor and a second terminal coupled to the first capacitor through a second resistor. In some embodiments, the second terminal of the first resistor is coupled to ground through a third resistor, and wherein the voltage across the third resistor is the output voltage. In some embodiments the second terminal of the first resistor is coupled to ground through a third diode. In some embodiments, the first state is a closed state and the second state is an open state. In some embodiments the switch is a transistor.

According to another aspect of the disclosure there is provided a method of estimating the voltage across a primary winding of a transformer of a flyback converter from the secondary-side of the transformer. The method includes the placing a switch coupled to the primary winding of the transformer in a first state to reverse bias a first diode coupled to the secondary winding of the flyback converter and establish an output voltage of a primary voltage sensing circuit coupled to the secondary winding of the transformer; and estimating the voltage across the primary winding of the transformer from the output voltage.

In some embodiments of the method of estimating the voltage across a primary winding of a transformer of a flyback converter from the secondary-side of the transformer, the primary voltage sensing circuit includes a second diode coupled to the secondary winding, the second diode being configured to be forward biased when the first diode is reverse biased. In some embodiments the second diode is coupled to the secondary winding and to ground through a second capacitor. In some embodiments, the primary voltage sensing circuit further includes a first resistor having a first terminal coupled to the second diode and the second capacitor and a second terminal coupled to the first capacitor through a second resistor. In some embodiments, the second terminal of the first resistor is coupled to ground through a third resistor, and wherein the voltage across the third resistor is the output voltage. In some embodiments the second terminal of the first resistor is coupled to ground through a third diode. In some embodiments, the first state is closed state and the second state is an open state. In some embodiments the switch is a transistor.

### BRIEF DESCRIPTION OF THE DRAWINGS

Reference should be made to the following detailed description which should be read in conjunction with the following figures, wherein like numerals represent like parts:

FIG. 1 is a schematic diagram of one example embodiment of a system consistent with the present disclosure.

FIG. 2 is a schematic diagram of another example embodiment of a system consistent with the present disclosure.

FIG. 3 includes plots of voltage vs. time illustrating the voltage across a secondary winding and a voltage across a capacitor of a primary voltage sensing circuit consistent with the present disclosure.

FIG. 4 is a plot of the output voltage of a primary voltage sensing circuit vs. the voltage across the primary winding associated with a system consistent with the present disclosure.

FIG. 5 is a flowchart illustrating one method consistent with the present disclosure.

### DETAILED DESCRIPTION

Embodiments provide many advantages, including the addition of only a few extra components (e.g., a capacitor, two diodes, and three resistors in some embodiments), all of which are relatively small in size (e.g., 0603/0805-size SMD components) and thus take up little space on a printed circuit board compared to an optocoupler and its related circuitry. Additionally, the communication signal is analog, not digital as with an optocoupler, and thus the bandwidth can be designed to be very high without the need of costlier components.

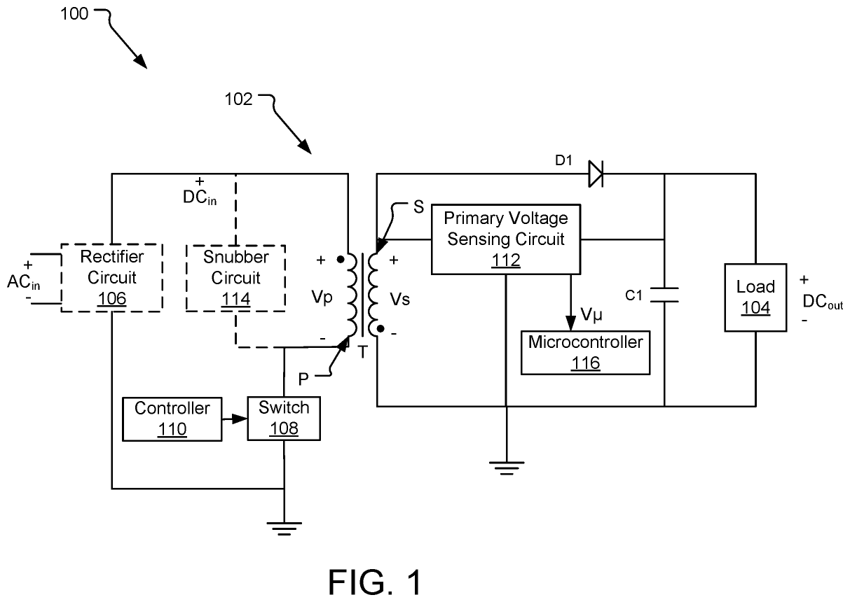

FIG. 1 is a schematic diagram of one example embodiment 100 of a system consistent with the present disclosure. In general, the system includes a flyback converter circuit 102 consistent with the present disclosure for receiving either an alternating current (AC) input ACᵢₙ, directly or through a known dimmer circuit, or a direct current (DC) input DCᵢₙ, and providing a regulated DC output DCₒᵤₜ for driving a load 104. The load 104 may be one or more solid state light sources, including but not limited to groups of LED(s) interconnected in series and/or parallel configurations; a power supply input for primary or secondary microcontrollers or application specific integrated circuits (ASICS); and other loads requiring a stable DC input.

In embodiments configured to receive an AC input, the AC input ACᵢₙ may be a provided directly from a 120 VAC/60 Hz line source or from other AC sources, such as a 220-240 VAC at 50-60 Hz, a 12 VAC source, etc. In general, the AC input voltage ACᵢₙ is coupled to an optional rectifier circuit 106, either directly or through a dimmer circuit. The rectifier circuit 106 may be configured to rectify the AC input ACᵢₙ to provide a DC input DCᵢₙ to the flyback converter circuit 102. A variety of rectifier circuit configurations are well-known in the art. In one embodiment, for example, the rectifier circuit 106 may include a known diode bridge rectifier or a known field effect transistor (FET) bridge rectifier. Alternatively, a system 100 consistent with the present disclosure may operate from a DC source that provides the DC input DCᵢₙ directly to the flyback converter circuit 102.

In the illustrated example embodiment, the flyback converter circuit 102 includes a transformer T with a primary winding P and a secondary winding S, a switch 108, a controller 110, a primary voltage sensing circuit 112, a diode D1, an output capacitor C1 and an optional snubber circuit 114. The transformer T, the switch 108, the controller 110, the diode D1 and the output capacitor C1 may take known configurations and are configured to provide known flyback converter operation. As shown, on the primary-side of the transformer T, the DC input DCᵢₙ is coupled to a positive polarity terminal of the primary winding P. The negative polarity terminal of the primary winding P is coupled to ground through the switch 108. During operation, a primary winding voltage Vp is established across the primary winding P and a secondary winding voltage Vs is established across the secondary winding S.

As is well-known, the switch 108 may be a transistor, e.g., a field effect transistor (FET) such as a metal oxide semiconductor field effect transistor (MOSFET). The controller 110 provides an output signal to the switch 108 to cycle the switch 108 between a first state, e.g., a closed or conducting state, and a second state, e.g., an open or non-conducting state. A variety of controllers for controlling operation of a flyback converter switch are well-known and commercially available. The optional snubber circuit 114 may be coupled across the primary winding P and to the switch 108 for limiting the peak voltage across the switch 108.

On the secondary-side of the transformer T, the positive polarity terminal of the secondary winding S is coupled to ground. The negative polarity terminal of the secondary winding S is coupled to the diode D1. The output capacitor C1 is coupled between the diode D1 and ground and the DC output DCₒᵤₜ is provided across the output capacitor C1.

When the switch 108 is closed, current flows through the primary winding P of the transformer T, establishing the primary winding voltage Vp. The flow of current through the primary winding P induces a negative voltage Vs across the secondary winding S. The negative voltage Vs across the secondary winding S reverse biases the diode D1. This continues for a predetermined amount of time, during which energy is stored in the transformer T. The switch 108 is then opened. Opening the switch 108 abruptly ceases current flow through the primary winding P, which induces a positive voltage Vs across the secondary-side winding S. The induced positive voltage Vs forward biases the diode D1, thereby allowing current to flow through the secondary winding S to charge the output capacitor C1 as the transformer T releases stored energy. When the energy stored in the transformer T has been exhausted, the current through the secondary winding S drops to zero. The switch 108 is then closed again and the cycle is repeated. The controller 110 provides an output to cycle the switch 108 between open and closed states at a predetermined frequency in order to provide the stable DC output voltage DCₒᵤₜ.

The primary voltage sensing circuit 112 is coupled to the secondary winding S and is configured to provide an output voltage Vμ, e.g., to a microcontroller 116, that is representative of the primary-side voltage Vp. The value of Vp may be estimated, e.g. in the microcontroller 116, from the value of Vμ and may be used for various purposes. For example, information regarding the value of Vp may be estimated from Vμ to provide timely saving of non-volatile memory inside a secondary-side microcontroller, to detecting faults, to go into a fail-safe mode, etc.

In general, when the switch 108 is closed the diode D1 is reverse biased. During this time, a current is induced in secondary winding S and the primary voltage sensing circuit 112 to establish the voltage Vμ while energy is stored in the secondary winding S. When the switch 108 is opened, current flow through the primary winding P is ceased, as described above, which induces a positive voltage Vs across the secondary winding S. In this state, current flow from the secondary winding S to the primary voltage sensing circuit 112 is blocked and the diode D1 is forward biased. When D1 is forward biased current flows through the secondary winding S and D1 to charge the output capacitor C1 as the transformer T releases stored energy.

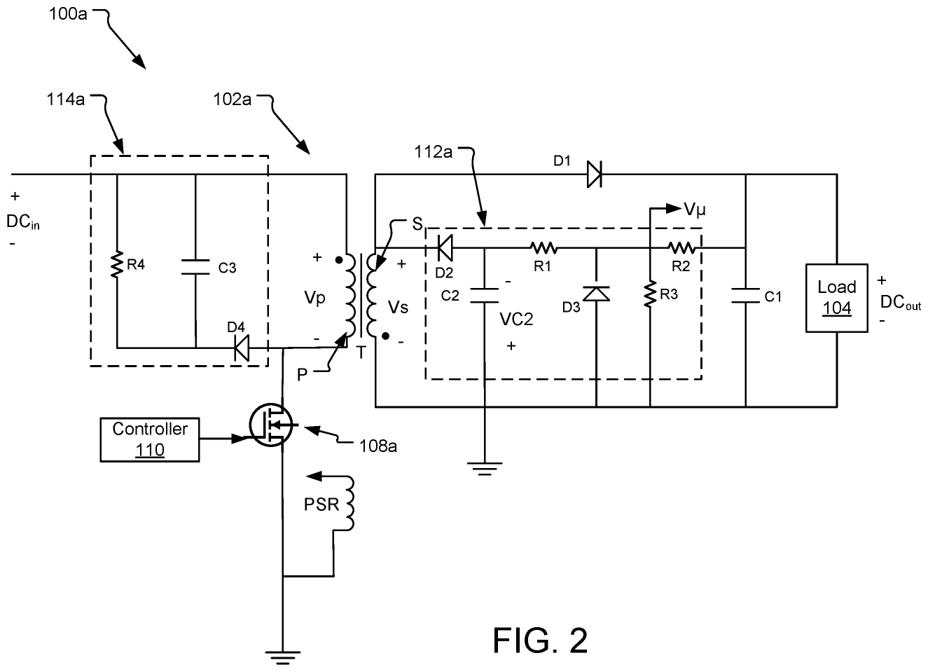

A system consistent with the present disclosure and a primary voltage sensing circuit consistent with the present disclosure may be provided in a variety of configurations. One example embodiment 100a of a system consistent with the present disclosure is shown in FIG. 2. As described in connection with the embodiment shown in FIG. 1, the system 100a receives an input voltage DCᵢₙ, either directly or from the output of an AC rectifier circuit 106 (FIG. 1) and provides a regulated DC output voltage DCₒᵤₜ for driving a load 104. In the illustrated example embodiment, the voltage across the secondary winding Vs is regulated, in a known manner, by a closed-loop feedback that employs a primary-side regulation (PSR) winding of the transformer T.

The illustrated example embodiment 100a includes a flyback converter 102a including a transformer T with a primary winding P and a secondary winding S, a switch 108a, a controller 110, a primary voltage sensing circuit 112a, a diode D1, an output capacitor C1 and an optional snubber circuit 114a. The switch 108a is configured as a single MOSFET. The controller is coupled to the gate of the switch 108a. The drain of the switch 108a is coupled to the negative polarity terminal of the primary winding P and the snubber circuit 114a. The source of the switch 108 is coupled to ground. The optional snubber circuit 114a is a known configuration including a diode D4 coupled in series with a parallel combination of a resistor R3 and a capacitor C3. The snubber circuit 114a limits the peak drain-to-source voltage of the MOSFET switch 108a.

As is known, the controller 110 provides an output to control the gate voltage of the switch 108a to control the conducting state of the switch 108a. When the switch 108a is conducting, the switch is in a “closed” state and when the switch 108a not conducting the switch is in an “open” state. The transformer T, the switch 108a, the controller 110, the diode D1 and the output capacitor C1 provide known flyback converter operation in the manner described above in connection with FIG. 1.

In the illustrated example embodiment, the primary voltage sensing circuit 112a includes a diode D2, a capacitor C2, a resistor R1, a diode D3, and resistors R2 and R3. As shown, the diode D2 is coupled to the negative polarity terminal of the secondary winding S and to ground through the capacitor C2. The resistor R1 is coupled to the diode D2 and the output capacitor C1 and to ground through the parallel combination of the diode D3 and the resistor R3. One terminal of the resistor R2 is coupled to the parallel combination of the diode D3 and the resistor R3 and an opposite terminal of the resistor R2 is coupled between the diode D1 and the output capacitor C1. In the illustrated example embodiment, the voltage Vμ is the voltage across the resistor R3.

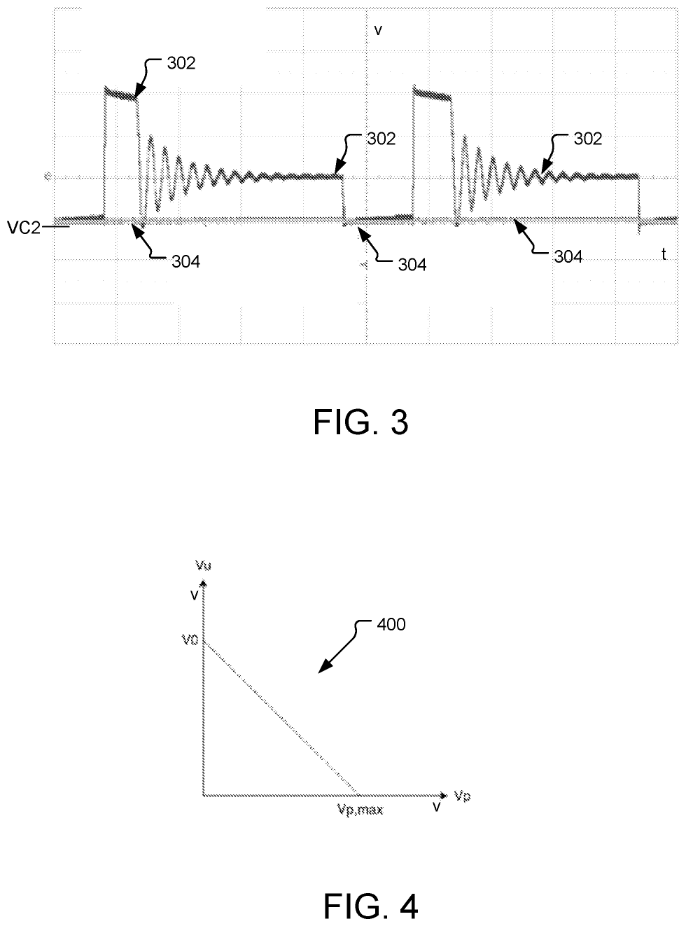

When the MOSFET switch 108a is conducting (the switch is closed), the diode D1 is reverse biased and the diode D2 is forward biased. During this time, the capacitor C2 charges to a voltage VC2 representative of the peak voltage Vs,pk− across the secondary winding S. The diode D2 and the capacitor C2 thus act a negative peak detector for the peak voltage Vs,pk− across the secondary winding S. FIG. 3 includes plots 302, 304 of measured voltage (v) vs. time (t) illustrating the voltage Vs across the secondary winding S during operation of the flyback converter 102a and illustrating the voltage VC2 across the capacitor C2, respectively. As shown, the capacitor C2 charges to a voltage VC2 approximating the negative peak voltage Vs,pk− across the secondary winding S, and holds that charge as the switch 108a cycles between open and closed states.

The peak voltage Vs,pk− across the secondary winding S and the voltage VC2 across the capacitor C2 can be described as:

$${V}_{s , pk -} = {V}_{C 2} = - \frac{{N}_{s}}{{N}_{p}} {V}_{p} \qquad ( 1 )$$

where Ns is the number of windings in the secondary-side S of the transformer T and Np is the number of windings in the primary-side P of the transformer T.

As can be seen in equation (1), the peak voltage Vs,pk− across the secondary winding S is negative with respect to the secondary-side ground. In addition, the magnitude of the voltage Vs,pk− can be quite high compared to the voltage Vs. Therefore, in order to measure the voltage Vs,pk−, e.g., by a microcontroller 116, it is scaled down by a voltage divider established by the resistors R1 and R3, and then shifted up by the resistors R2 and R3, to make it positive, providing the output voltage Vμ across R3. The diode D3 clamps the negative voltages to zero to ensure safety of the microcontroller 116 analog-to-digital (ADC) channels, especially during startup when Vs has not built up yet.

Using the superposition principle, the voltage Vμ, can be described as:

$${V}_{μ} = \frac{( {R}_{2} ‖ {R}_{3} )}{{R}_{1} + ( {R}_{2} ‖ {R}_{3} )} {V}_{C 2} + \frac{( {R}_{1} ‖ {R}_{3} )}{{R}_{2} + ( {R}_{1} ‖ {R}_{3} )} {V}_{s} \qquad ( 2 )$$

Therefore, considering (1), equation (2) can be rewritten as:

$${V}_{μ} = - \frac{{N}_{s}}{{N}_{p}} \cdot \frac{( {R}_{2} ‖ {R}_{3} )}{{R}_{1} + ( {R}_{2} ‖ {R}_{3} )} {V}_{p} + \frac{( {R}_{1} ‖ {R}_{3} )}{{R}_{2} + ( {R}_{1} ‖ {R}_{3} )} {V}_{s} \qquad ( 3 )$$

The voltage Vμ should always be positive for processing by a microcontroller:

V_{μ}≥0 (4)

Hence,

$$\frac{{N}_{s}}{{N}_{p}} \cdot \frac{( {R}_{2} ‖ {R}_{3} )}{{R}_{1} + ( {R}_{2} ‖ {R}_{3} )} {V}_{p} \leq \frac{( {R}_{1} ‖ {R}_{3} )}{{R}_{2} + ( {R}_{1} ‖ {R}_{3} )} {V}_{s} \\ \to {V}_{p} \leq \frac{{N}_{p}}{{N}_{s}} \cdot \frac{{R}_{1} + ( {R}_{2} ‖ {R}_{3} )}{( {R}_{2} ‖ {R}_{3} )} \cdot \frac{( {R}_{1} ‖ {R}_{3} )}{{R}_{2} + ( {R}_{1} ‖ {R}_{3} )} {V}_{s} = \frac{{N}_{p}}{{N}_{s}} \cdot \frac{{R}_{1}}{{R}_{2}} {V}_{s} \\ and \qquad ( 5 )$$

$${V}_{p , max} = \frac{{N}_{p}}{{N}_{s}} \cdot \frac{{R}_{1}}{{R}_{2}} {V}_{s} \qquad ( 6 )$$

Equation (6) puts a limit on the maximum primary-side voltage Vp that can be measured. It is possible to adjust the resistor R1 and/or the resistor R2 to change this upper limit.

On the other hand, when the primary-side voltage Vp is equal to zero, the voltage Vμ is at its maximum according to (3), which is:

$${V}_{0} = \frac{( {R}_{1} ‖ {R}_{3} )}{{R}_{2} + ( {R}_{1} ‖ {R}_{3} )} {V}_{s} \qquad ( 7 )$$

FIG. 4 is a plot of the output voltage Vμ of the primary voltage sensing circuit vs. the voltage Vp across the primary winding P and depicts a linear the relationship between the output voltage Vμ and the voltage Vp across the primary winding P. The maximum voltage Vp,max across the primary winding P and V0 are constant variables that only depend on the hardware parameters. Therefore, it is possible to reduce equation (3) into

$${V}_{μ} = {V}_{0} ( 1 - \frac{{V}_{p}}{{V}_{p , max}} ) \qquad ( 8 )$$

Equation (8) describes a simple linear relationship between the output voltage Vμ and the voltage Vp across the primary winding P as illustrated in FIG. 3. Assuming that the output voltage Vμ is given, the voltage Vp across the primary winding P can be described as

$${V}_{p} = {V}_{p , max} ( 1 - \frac{{V}_{μ}}{{V}_{0}} ) \qquad ( 9 )$$

Equation (9) provides a simple way to estimate the voltage Vp across the primary winding P based on the output voltage Vμ of the primary voltage sensing circuit 112a. The constants Vp,max and V0 depend only on the hardware parameters and may be defined in the firmware of the microcontroller 116. Therefore, using equations (6), (7), and (9), e.g., in the microcontroller 116, it is possible to indirectly estimate the voltage Vp across the primary winding P of the flyback converter 102a without breaking the galvanic isolation or using a cost-intensive optical communication devices and circuitry.

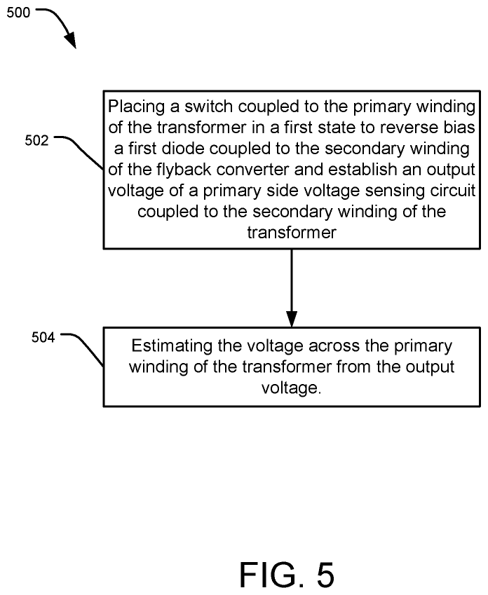

FIG. 5 is a flowchart illustrating one example of a method consistent with the present disclosure consistent with the present disclosure. The illustrated flow chart may be shown and described as including a particular sequence of steps. It is to be understood, however, that the sequence of steps merely provides an example of how the general functionality described herein can be implemented. The steps do not have to be executed in the order presented unless otherwise indicated.

FIG. 5 illustrates a method 500 of estimating the voltage across a primary winding of a transformer of a flyback converter from the secondary-side of the transformer. The method includes placing 502 a switch coupled to the primary winding of the transformer in a first state, e.g., a closed state, to reverse bias a first diode, e.g., D1 in FIGS. 1 and 2, coupled to the secondary winding of the flyback converter and establish an output voltage Vμ of a primary voltage sensing circuit coupled to the secondary winding of the transformer. As described above, when the first diode is reversed biased, energy may be stored in the transformer. When the switch is placed in a second state, e.g., an open state, the first diode may be forward biased and energy from the transformer may charge an output capacitor, e.g., C1 in FIGS. 1 and 2, to provide a stable DC output voltage. The method further comprises estimating 504 the voltage across the primary winding of the transformer from the output voltage.

The methods and systems described herein are not limited to a particular hardware or software configuration and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors and may be stored on one or more storage medium readable by the processor (including volatile and non-volatile memory and/or storage elements), one or more input devices, and/or one or more output devices. The processor thus may access one or more input devices to obtain input data and may access one or more output devices to communicate output data. The input and/or output devices may include one or more of the following: Random Access Memory (RAM), Redundant Array of Independent Disks (RAID), floppy drive, CD, DVD, Blu-Ray, magnetic disk, internal hard drive, external hard drive, memory stick, flash drive, solid state memory device, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s), handheld device(s) such as cellular telephone(s) or smartphone(s) or tablet(s), laptop(s), laptop/tablet hybrid(s), handheld computer(s), smart watch(es), or any other device(s) capable of being integrated with a processor(s) that may operate as provided herein. Accordingly, the devices provided herein are not exhaustive and are provided for illustration and not limitation.

References to a “controller”, a “microcontroller”, “a microprocessor” and “a processor”, or “the controller”, “the microcontroller”, “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “controller”, a “microcontroller”, “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

The term “coupled” as used herein refers to any connection, coupling, link or the like by which signals carried by one system element are imparted to the “coupled” element. Such “coupled” devices, or signals and devices, are not necessarily directly connected to one another and may be separated by intermediate components or devices that may manipulate or modify such signals. Likewise, the terms “connected” or “coupled” as used herein in regard to mechanical or physical connections or couplings is a relative term and does not require a direct physical connection.

As used in any embodiment herein, a “circuit” or “circuitry” may comprise hardware or software, or a combination of hardware and software, for example, singly or in any combination, hardwired circuitry, programmable circuitry, state machine circuitry, and/or firmware that stores instructions executed by programmable circuitry. In at least one embodiment, the controller 110 may comprise one or more integrated circuits. An “integrated circuit” may be a digital, analog or mixed-signal semiconductor device and/or microelectronic device, such as, for example, but not limited to, a semiconductor integrated circuit chip.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously, many modifications and variations may become apparent in light of the above teachings. Many additional changes in the details, materials, and arrangement of parts, herein described and illustrated, may be made by those skilled in the art.

What is claimed is:

1. A flyback converter circuit comprising:
a transformer having a primary winding and a secondary winding;
a switch coupled to the primary winding, the switch having a first state and a second state;
a controller coupled to the switch configured to cycle the switch between the first and second states to control current flow through the primary winding;
a first diode coupled the secondary winding, the first diode configured to be reverse biased when the switch is in the first state to allow energy to be stored in the transformer;
an output capacitor coupled to the first diode, the first diode being configured to be forward biased when the switch is in the second state to allow energy in the transformer to charge the output capacitor; and
a primary voltage sensing circuit coupled to the second winding and being configured to establish an output voltage when the switch is in the first state and the first diode is reversed biased, the output voltage being representative of a voltage across the primary winding.

2. A circuit according to claim 1, wherein the primary voltage sensing circuit comprises a second diode coupled to the secondary winding, the second diode being configured to be forward biased when the first diode is reverse biased.

3. A circuit according to claim 2, wherein the second diode is coupled to the secondary winding and to ground through a second capacitor.

4. A circuit according to claim 3, wherein the primary voltage sensing circuit further comprises a first resistor having a first terminal coupled to the second diode and the second capacitor and a second terminal coupled to the first capacitor through a second resistor.

5. A circuit according to claim 4, wherein the second terminal of the first resistor is coupled to ground through a third resistor, and wherein the voltage across the third resistor is the output voltage.

6. A circuit according to claim 5, wherein the second terminal of the first resistor is coupled to ground through a third diode.

7. A circuit according to claim 1, wherein the first state is closed state and the second state is an open state.

8. A circuit according to claim 1, wherein the switch is a transistor.

9. A method of estimating the voltage across a primary winding of a transformer of a flyback converter from the secondary-side of the transformer, the method comprising:
placing a switch coupled to the primary winding of the transformer in a first state to reverse bias a first diode coupled to the secondary winding of the flyback converter and establish an output voltage of a primary voltage sensing circuit coupled to the secondary winding of the transformer;
estimating the voltage across the primary winding of the transformer from the output voltage.

10. A method according to claim 9, wherein the primary voltage sensing circuit comprises a second diode coupled to the secondary winding, the second diode being configured to be forward biased when the first diode is reverse biased.

11. A method according to claim 10, wherein the second diode is coupled to the secondary winding and to ground through a second capacitor.

12. A method according to claim 11, wherein the primary voltage sensing circuit further comprises a first resistor having a first terminal coupled to the second diode and the second capacitor and a second terminal coupled to the first capacitor through a second resistor.

13. A method according to claim 12, wherein the second terminal of the first resistor is coupled to ground through a third resistor, and wherein the voltage across the third resistor is the output voltage.

14. A method according to claim 13, wherein the second terminal of the first resistor is coupled to ground through a third diode.

15. A method according to claim 9, wherein the first state is closed state.
